(19) United States
(12) Patent Application Publication
(10) Pub. No.: US 2015/0181351 A1
(43) Pub. Date: Jun. 25, 2015

(54) Time Cycle Audio Recording Device

(71) Applicant: Nugg-It, LLC, Cincinnati, OH (US)

(72) Inventors: Mike E. Sarow, Cincinnati, OH (US); Matthew R. Dooley, Newport, KY (US)

(73) Assignee: Nugg-It, LLC, Cincinnati, OH (US)

(21) Appl. No.: 14/415,227

(22) PCT Filed: Jul. 17, 2013
(86) PCT No.: PCT/US2013/050877

§ 371 Date: Jan. 16, 2015

Related U.S. Application Data
(60) Provisional application No. 61/672,394, filed on Jul. 17, 2012.

(51) Int. Cl. H04R 23/00

(52) U.S. Cl. CPC H04R 23/00

(57) ABSTRACT

A wrist-wearable, battery powered device (10) for recording audio uses circuitry to record audio in a continuous, looped fashion, and a processor which can be triggered to store a segment of previously recorded audio. Vibration circuitry (34) in the device is used to generate and respond to vibration so that a user can enable or disable recording (308, 314) and direct the storage of recorded audio (302) by mechanicaily tapping the device, and the processor can confirm user directions relating to recording of audio by responsively generating vibration of the device (304, 310, 316). A signal light (317) also provides visual confirmation of the device status and activity. Stored audio is transferred wirelessly or via a USB connection (19) to a remote computing device such as a smartphone, laptop or palmtop for editing, storage and sharing via social networks and the like.

### RELATED APPLICATION

The present application claims priority to U.S. Provisional Application Ser. No. 61/672,394 filed Jul. 17, 2012, the disclosure of which is hereby incorporated herein by reference in its entirety.

### FIELD OF THE INVENTION

The present invention relates to personal accessories for sound recording, usable in conjunction with mobile palm and tablet sized devices.

### BACKGROUND OF THE INVENTION

Mobile devices have become ubiquitous and they are now used for a wide variety of applications including photography, navigation, music playback, web page retrieval and many others. Mobile devices can also be used for media (audio, video, or audio/video) recording, using an internal microphone and/or camera and sound recording application (app), however, there are limitations in this use, specifically, the app typically must be enabled to begin media recording, meaning that the recording must be initiated prior to the event to be recorded, which is useful for posed photographs and staged musical events, but not useful for spontaneous recordings of unscripted moments such as conversations.

There are known devices which continuously record audio and/or video, such as security cameras, dashboard cameras, and the like, but these are generally not battery powered and mobile so that they often cannot be used in contexts where an unscripted moment of interest may be likely to occur, such as an impromptu personal conversation.

Thus, there is a need for a mobile, battery powered, compact device that can provide an audio recording capability, with relatively long battery life, and without substantial hardware cost.

### SUMMARY OF THE INVENTION

In one aspect in accordance with principles of the present invention, this need is met by a wrist-wearable, battery powered device including circuitry to record audio in continuous, looped fashion, which is connectible to an attached computing device, e.g. smartphone, palmtop, laptop, to capture segments of previously recorded audio for preservation or manipulation by the attached computing device.

As disclosed herein, the computing device is connected via Bluetooth, but may also be connected using a variety of other standard communication interfaces such as WiFi, Zigbee, and the like.

In another aspect in accordance with principles of the present invention, the invention features a wrist-wearable, battery powered device including audio recording circuitry and vibration circuitry to generate and respond to vibration, enabling a user to direct the storage of recorded audio by mechanically tapping the device, and enabling confirmation of user directions relating to recording of audio by responsively generating vibration.

As disclosed herein, a segment, e.g. 1 minute, of previously recorded audio is stored by the device in response to one tap of the device, and the storage of a segment of audio is confirmed by a vibration. Further, the device enables continuous recording of audio in response to two quickly sequenced taps of the device, and confirms this state by generating three quickly sequenced vibration pulses. Also, the device disables continuous recording of audio in response to three quickly sequenced taps of the device, and confirms this state by generating three quickly sequenced vibration pulses.

Additional objects and advantages of the invention will be apparent from the attached drawings, in which:

### BRIEF DESCRIPTION OF THE DRAWINGS

FIG. 1 is a perspective top view Illustration of a wrist wearable device in accordance with principles of the present invention;

FIG. 2A is an exploded view of the mobile device accessory of FIG. 1 showing the manner in which the housing of the internal circuit board is uncoupled from the wrist band;

FIG. 2B is a further exploded view showing the manner in which the complementary wristband sections are disengaged and the housing skin has been removed;

FIG. 2C is a cross sectional view showing the positioning of components in the assembled device when locked in a particular circumference around a user's wrist;

FIG. 3 is a perspective view of the circuitry on the circuit board of the device of FIG. 1;

FIG. 4 is a flow chart of operations performed by the device and a connected computing device in accordance with principles of the present invention; and

FIG. 5 is a flow chart of the interaction of the device using the tap-vibration interface in accordance with principles of the present invention.

### DETAILED DESCRIPTION OF THE INVENTION

The present invention features a wearable, personal electronics device that has the useful purpose of continuously recording audio in the vicinity of the device, so that a previous segment or “snippet” (e.g., 1 minute) of audio can be captured when desired in an audio file.

In the disclosed embodiment, data representing audio acquired during a chosen segments of time are stored as individual files which are held in the device until erased (recorded over). The user of the device may transfer these individual files by interfacing with the device with an associated computing device having a larger memory capacity, such as a smartphone, palmtop or laptop computer.

Recordings that are transferred as a file can be kept in a computing device for storage, sent via email, or uploaded to the Internet, social networks or the like as the individual user sees fit.

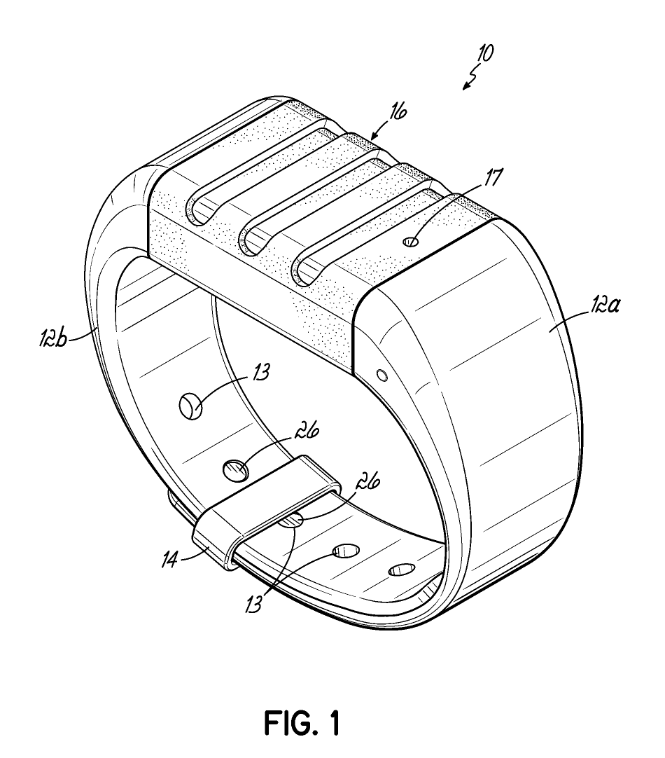

Referring now to FIG. 1, in accordance with principles of the present invention, recordings are captured by a wristband shaped device 10, having band sections 12a and 12b which are clasped together by a clasp 14, and coupled to a central housing 16 which contains the electronics that implement principles of the present invention. As explored below, the electronics in the central housing 16 may include: a battery (32, FIG. 3), memory, a microphone (37, FIG. 3), software or hardware on/off switching electronics, an on/off indicator or signal light 17 and/or, alternatively, a more complex display such as a dot matrix or LCD segment display (not shown), a vibration circuit for detecting and generating vibration to control the recording of sound (34, FIG. 3) and/or, alternatively, a “Click to Capture” button (not shown), circuitry providing file transfer capabilities (e.g., wifi, Bluetooth, see 36, FIG. 3), and optionally a speaker (not shown). The central housing 16 is preferably waterproof to enable use of the device in outdoor environments.

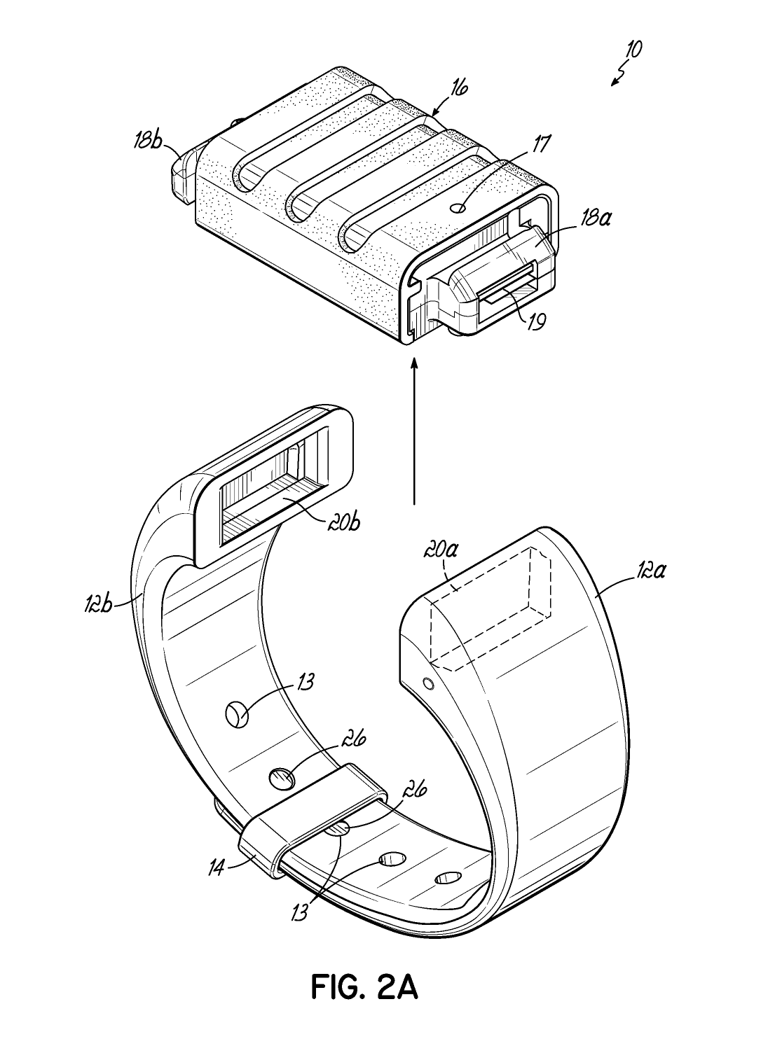

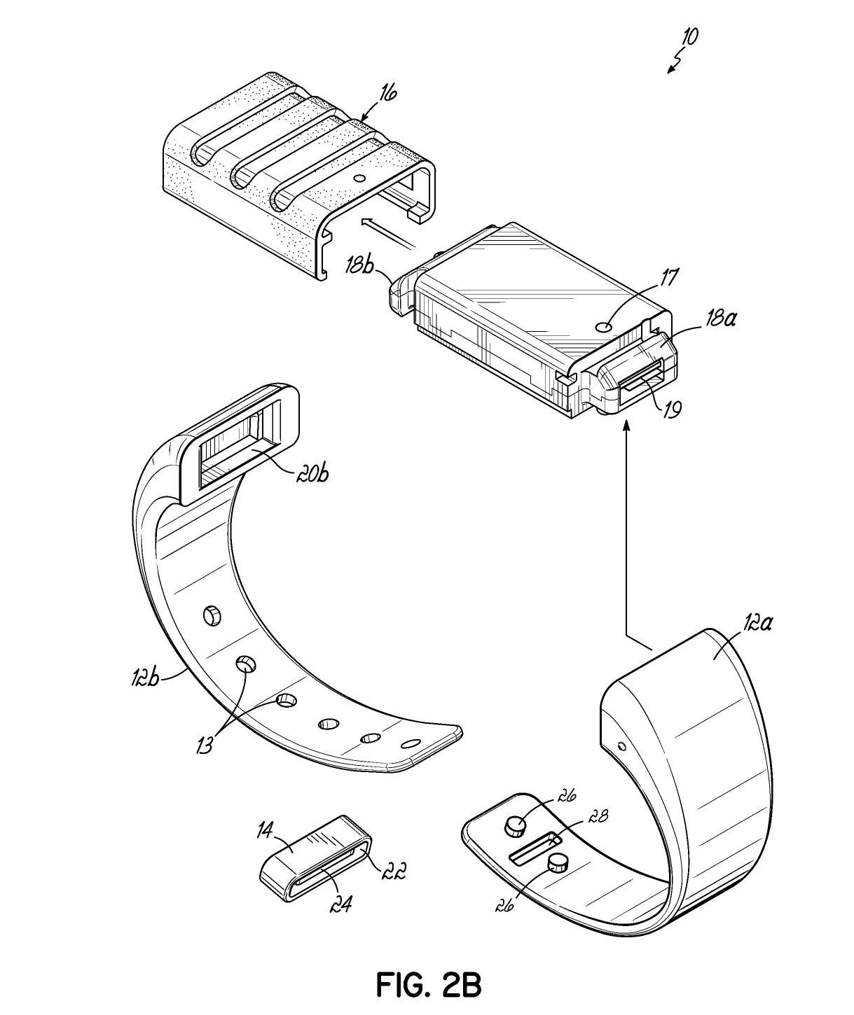

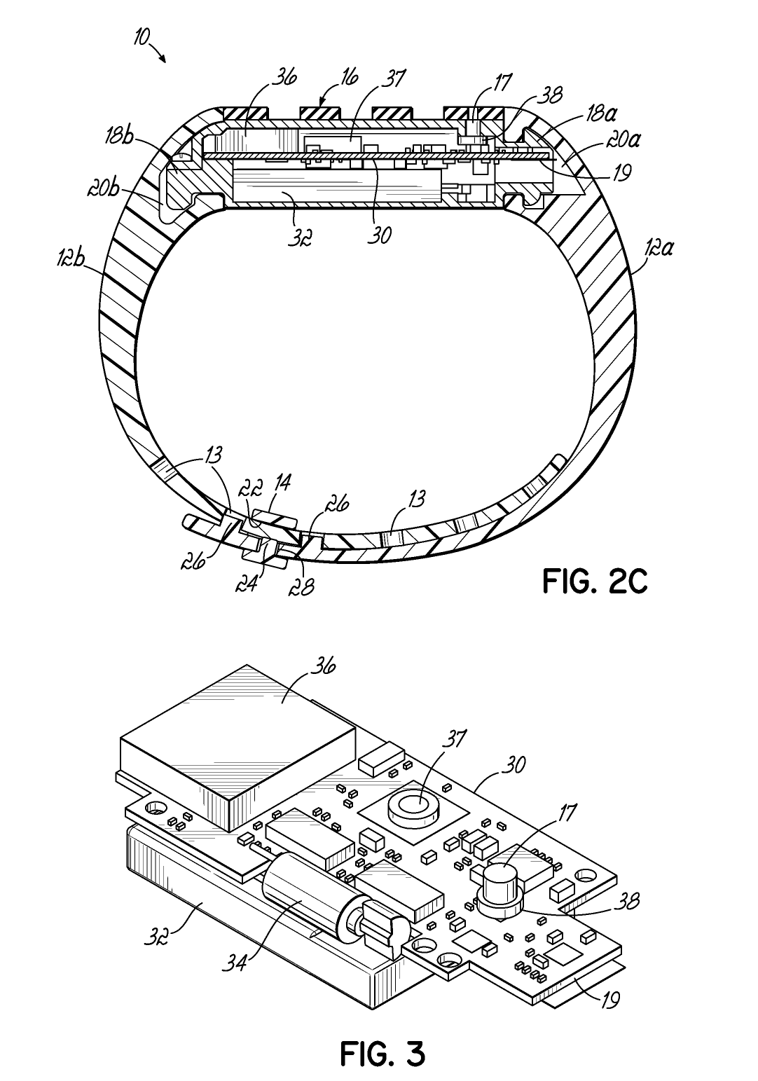

Referring now to FIG. 2A, the central housing 16 includes projections 18a and 18b on each end thereof, which engage to apertures 20a and 20b on the band sections 12a and 12b, respectively, to connect the central housing 16 to the band sections 12a and 12b. The central housing 16 further incorporates a micro USB connector 19 which is usable to make wired connections to the central housing 16 to enable charging of the internal battery, as well as transfer of files and firmware upgrades without the use of wireless methods.

FIG. 2Billustrates the band sections 12a and 12b disengaged from each other, and the housing skin 16 removed from the internal housing. The skin and band sections may be made available in various colors or designs, and exchangeable for fashion purposes by the user as an additional feature of the device.

FIG. 2B and FIG. 2C illustrates the engagement mechanism used to hold the band sections 12a and 12b to each other about a user's wrist. Band section 12a includes male projections 26 as well as a slot 28, and band section 12b includes female holes 13. First, clasp 14 is slid onto band section 12b above the holes 13. Next, the two projections 26 are selectively inserted in a pair of the holes 13 to appropriately size the device for the user's wrist. Then, clasp 14 is slid down band section 12b and over the joint between band section 12a and band section 12b, until the elongated projection 24 internal to clasp 14 engages into slot 28 included in band section 12a (see this engagement in cross section in FIG. 2C), thus holding the projections 26 into the selected holes 13 and holding the clasp 14 in position with an interference fit.

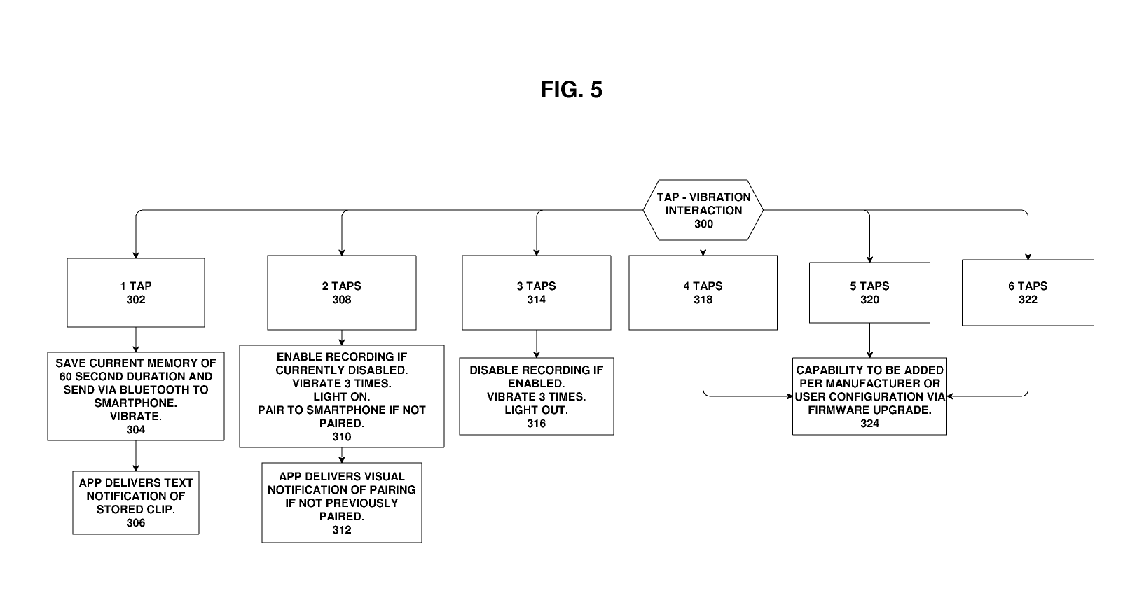

Referring now to FIG. 3, electronic components within the central housing 16 can be seen. These include the micro USB connector 19, battery 32, memory, microphone 17, processor, on/off indicator or signal light 17 which conveys light generated by an LED 38, vibration circuit 34 for detecting and generating vibration to control the recording of sound (see FIG. 5), and Bluetooth circuitry 36 to allow wireless file transfer and control by a wirelessly paired and connected computing device. The central housing 16 is preferably waterproof or watertight to enable use of the device in outdoor environments.

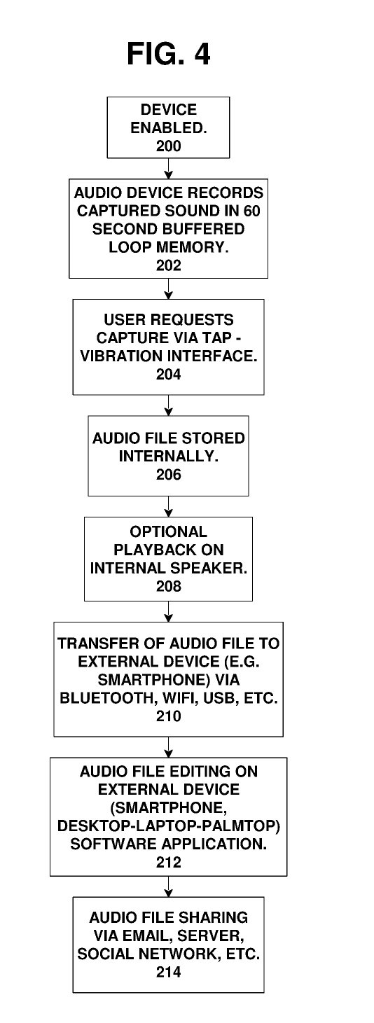

Referring now to FIG. 4, the general process of use of the device 10 can be elaborated. Initially, in step 200 the device is enabled for recording, e.g., using the tap-vibration interface described in greater detail in FIG. 5. Once enabled, in step 202 the device records captured sound in a 60 second buffered loop memory, so that the most recent 60 seconds of audio are continuously available for storage.

When the user desires a capture of a recent segment of audio, in step 204 the user requests the capture, using the tap-vibration interface. Then in step 206, a file of the contents of the buffered loop memory is stored. In an alternative embodiment in which the device includes an optional speaker, the next step could include playback of the recorded file via the speaker for verification. In step 208, the audio file is transferred to an external computing device, such as a smartphone or tablet device, via a wireless connection which would typically be a Bluetooth connection but could also use Wifi, Zigbee or other wireless protocols. Alternatively, the transfer could be via wired connection such as USB via the USB connector 19.

Once a recorded file is transferred to an external computing device, in step 212 the file may be edited on the external device using a software application or “app”. The type of editing and the software use may vary widely based upon the nature of the external device, which could be a smartphone, desktop computer, laptop computer, palmtop computer, tablet, or any other variant.

In step 213, the external device is used for sharing or storage of the audio file, e.g., via email, storage on a server, sharing through a social network, or the like.

Referring now to FIG. 5, the tap-vibration interface responds to taps to the device 10 which are detected by the vibration circuitry 34 (see FIG. 3), and produces responsive vibrations through the vibration circuitry 34.

A single tap 302 triggers the device to save 304 the current contents of the buffered loop memory into an audio file of 60 second duration, and then send that file via Bluetooth to a connected device such as a smartphone. Further, the device produces a responsive vibration to confirm this operation. The computing device app may also deliver a text notification 306 of the receipt of the stored audio clip.

A double tap 308 triggers the device to enable recording if recording is currently disabled. The device then produces 310 a responsive vibration in three short bursts to confirm that recording is enabled. Further, the signal light 17 is set to a slow pulsing state to confirm recording. The Bluetooth circuitry is also enabled to pair and/or connect to the remote computing device, if any. The app on the remote computing device will deliver 312 a visual notification of pairing and/or pairing if it is not already connected.

A triple tap 314 triggers the device to disable recording 316, if recording is enabled. The signal light 17 is set to a continuous “off” state.

A sequence of four taps 318, five taps 320 and six taps 322 may also be recognized by the firmware. The corresponding functions 324 may be defined as desired by the manufacturer or by the user via configuration in the remote computing device. The functions may change the length of the loop buffer to record longer or shorter audio segments, change timeout periods or the signal light behavior, for example.

It will be appreciated that a novel and inventive mobile device accessory, and novel applications therefor, have been described here. Applicant does not intend by this description and the details thereof to limit the scope of the invention being sought to be protected, but rather, that protection is to be defined by reference to the following claims.

What is claimed is:

1. A wrist-wearable, battery powered device for recording audio, comprising:
a. circuitry and an audio memory to record audio in continuous, looped fashion;
b. wireless circuitry for connection to an attached computing device; and
c. a processor enabling the recording of audio in a continuous looped fashion and triggerable to capturing a segment of previously recorded audio in the audio memory, and triggerable to transfer the segment to for preservation or manipulation by the attached computing device.

2. The device of claim 1 wherein the wireless circuitry uses a standard wireless communication protocol for communicating with a smartphone, palmtop, laptop, or desktop computing device.

3. The device of claim 2 wherein the wireless circuitry uses a communication protocol selected from the group consisting of Bluetooth, WiFi and Zigbee.

4. The device of claim 1 further comprising a universal serial bus connector for connection of the processor to a computing device via a wired connection.

5. A wrist-wearable, battery powered device for recording audio, comprising:
a. circuitry and an audio memory to record audio;
b. vibration circuitry to generate and respond to vibration; and
c. a processor responding to said vibration circuitry, and enabling a user to direct the storage of recorded audio by mechanically tapping the device, and enabling confirmation of user directions relating to recording of audio by responsively generating vibration of the device.

6. The device of claim 5 wherein the processor controls the audio recording circuitry to store in the memory a segment of previously recorded audio.

7. The device of claim 6 wherein a segment of previously recorded audio is stored by the device in response to one tap of the device.

8. The device of claim 6 wherein the storage of a segment of audio is confirmed by one or more vibrations of the device.

9. The device of claim 5 wherein the processor controls the audio recording circuitry to enable continuous recording of audio.

10. The device of claim 9 wherein a recording is enabled in response to two quickly sequenced taps of the device.

11. The device of claim 9 wherein recording is confirmed by one or more vibrations this state by one or more vibrations of the device.

12. The device of claim 10 wherein the processor disables continuous recording of audio in response to three quickly sequenced taps of the device.

13. The device of claim 12 wherein disabling of recording is confirmed by one or more vibrations of the device.
